(19) United States
(12) Patent Application Publication
(10) Pub. No.: US 2018/0119668 A1
(43) Pub. Date: May 3, 2018

(54) GRAVITATIONAL POWER PLANT FOR GENERATING ELECTRICITY

(71) Applicant: Erich RAPP, Boos (DE)

(72) Inventor: Erich RAPP, Boos (DE)

(21) Appl. No.: 15/123,956

(22) PCT Filed: Mar. 4, 2015
(86) PCT No.: PCT/EP2015/000486

§ 371 Date: Dec. 6, 2017

(30) Foreign Application Priority Data
Mar. 4, 2014 (DE) 10 2014 003 200.0

(51) Int. Cl. F03B 17/04; F03B 17/00

(52) U.S. Cl. CPC F03B 17/04; F05B 2240/40; F03B 17/005

(57) ABSTRACT

In order to increase the efficiency of a gravitational power plant for generating electricity, comprising at least one turbine and one drive cylinder having a piston weight that can move therein, which piston weight can be alternately lifted by the hydrostatic pressure in a low-lying water-pressure chamber, the water-pressure chamber according to the invention is divided by at least one partition into at least two, preferably four, sectors, wherein the particular piston weight is lifted to the maximum height at the end of the piston stroke in all sectors. Preferably, three such partitions are provided at equal distance from each other.

### TECHNICAL FIELD

A gravitational power plant is known from DE 10 2013 000 570 (of the present Applicant), to which the following description refers as well as to known turbines and drive cylinders as specified in said patent application.

### BACKGROUND

Tests have shown drawbacks in this prior art, namely that the maximum static water pressure was not reached by the primary pressure line, described therein. However, such a maximum pressure is desired to lift the plunger or piston weights (in the drive cylinders) to the maximum lift height. The permanent pressure drop is mainly caused by the fact that always two piston weights are simultaneously lifted and thus water (outlet) constantly flows out of the common water-pressure chamber. Therefore, the piston weights reach only about ¾% of the possible lifting height, being reachable at the maximum static water pressure of the water column h. Therefore, the output of this gravitational power plant is below its maximum power.

In addition, the above-mentioned primary pressure line cannot prevent a back pressure of the piston weights such reducing the flow rate of the turbines, as well as the piston speed. Thus, the two pistons can transport only a part of the maximum water volume on their lifting movement starting from low water level.

### SUMMARY

Therefore it is desired to ensure that each piston weight is lifted at the end of the piston strokes to the static water pressure of the available water column h and also the water flow of the turbines is effective, as well as the entire volume of the available quantity of water is continuously transported by the piston strokes up from low water level.

This object is solved with the features of claim 1, wherein the “harmful” water flow of the common water-pressure chamber in the above-mentioned prior art is now eliminated by the division of the water-pressure chamber of the piston system in several, especially four sectors or sections. Thus, the proposed (three) partitions walls 12 form (four) independent water-pressure sections in which each of the maximum, hydrostatic water pressure continues to successively lift the piston weights in appropriate time to the maximum height, starting from low water level.

Each of these four sections is preferably equipped with a turbine 13 and two drive-crosses 8. Thus, each section contributes to ¼ of the generated total amount of energy. In each of the four sections always one piston weight 7 is simultaneously in the upward movement as well as in each of the four section always one drive-cross 8 is simultaneously in rotation. The back pressure reducing the flow rate as caused by the piston weights is balanced by the increased number of piston strokes, which always take place simultaneously. Each piston stroke lifts ¼ of the total amount of water up to the top water level 2. Thus, each of the four turbines is traversed by ¼ of the total amount of water, so that the turbine rotation, the piston strokes and the drive-cross rotation in each section are carried out continuously and with an offset, evenly in sequence.

Compared to the prior art, now each section has its “own” water pressure chamber 6, each piston reaches up to its top position (with a gentle halt of the respective piston weight 7) and thus, the respectively associated water column H reaches the desired water level. Thus, each piston weight now reaches its maximum lifting height, as the absolute, static water pressure h is present at the respective lower piston surface. The weight of the piston and the pressure force of the water column h are the same in this position. At this moment, the rotation of the drive-cross is introduced (f. i. by releasing the previously vertical orientation of the drive cylinder) to be completed in about 20 seconds—cf. subsequent calculations).

The back pressure of the piston weights may cause a slowdown in water flow; therefore, practically a “traction” of two parts of water column h and h1 are united to the total water column H. The flow rates or amounts of water to the turbines and to the drive cylinders are thus perfectly matched. The slower the water flow, the higher is the (hydrostatic) water pressure.

### BRIEF DESCRIPTION OF THE DRAWINGS

FIG. 1 depicts a first gravitational power plant; and

FIG. 2 depicts a second gravitational power plant.

### DETAILED DESCRIPTION

The sequence of movements of the piston system is as follows: While in each section at one of the two drive-crosses 8, the piston stroke is in progress (each shown on the left), the second one of these drive-crosses 8 rotates at the same time by 90° (thus providing torque by pivoting around a central axis, marked by a cross), since the mass of heavy piston weight 7 (here at the right side of each lying drive cylinder) acts clockwise (cf. arrow in the fourth section) and thus provides a high torque on the central axis (possibly including a large gear). Subsequently this activity alternates between the two engine cylinders 14, as controlled on their undersides by a respective slide for water supply (cf. description in previous applications of the inventor). The same movement takes place at the same time also in the other three sections, but offset in e.g. 5 seconds intervals. Thus, one piston stroke starts and ends all 5 seconds. Consequently, a 90° rotation of the drive- cross begins and ends every 5 seconds, respectively.

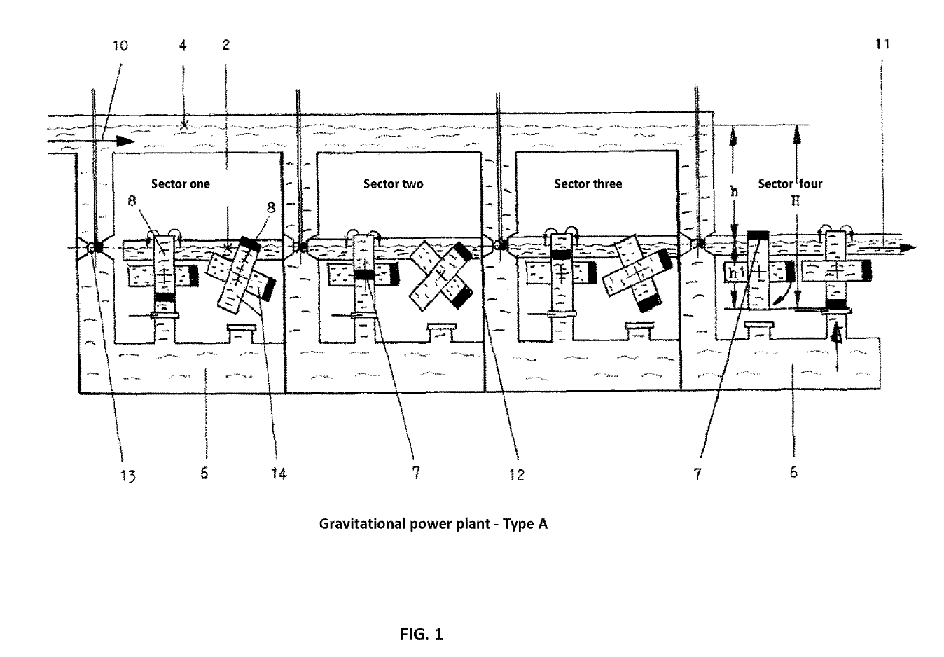

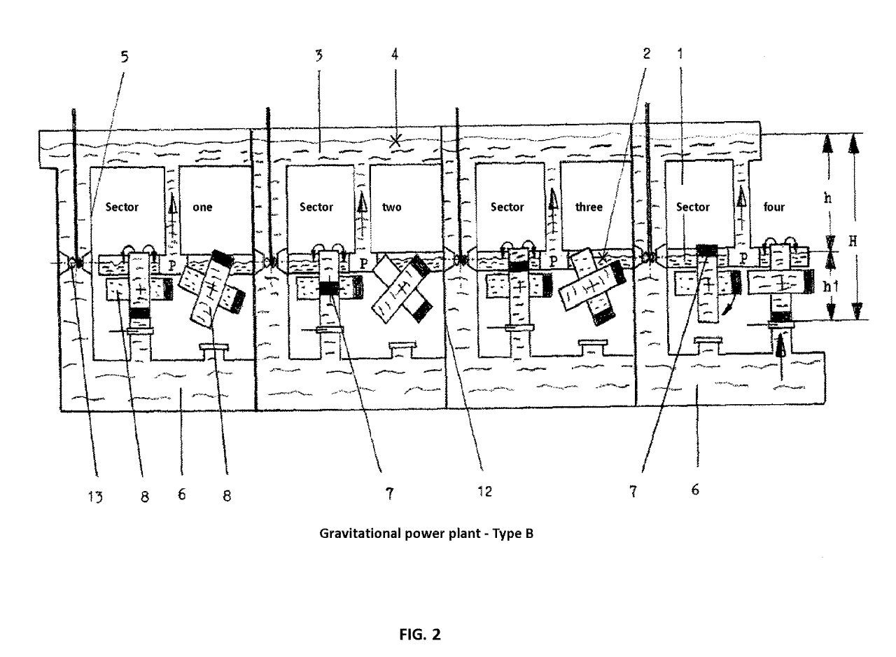

This continuous energy generation in the proposed gravitational power plant results in a substantially improved energy efficiency in comparison to a conventional hydropower plant. This application includes two types of the gravitational power plant, type A (FIG. 1) and type B (FIG. 2), which are largely identical. All drive-crosses 8 (each with two drive cylinders arranged in an angle of 90°, respectively, as illustrated in the image plane) have basically the same transmission mechanisms (e.g. large gears) to one or more generators for electric energy. In plant type A water flows from a (natural) storage 10 and then, after generating use, back as shown by outlet water 11. In plant type B water is not brought to the drain, but is re-circulated from low water level 2 to the upper water level 4 by pumping, to drain again in the manner of a reservoir.

Comparative data are derived from a selected example, namely the conventional hydroelectric power plant (in Oberelchingen/Donau river):

Drop height =5.75 m

Total amount of water Q=210 m³/s, each 105 m³/s for each of 2 turbines;

Free falling velocity V=10.6 m/s

Calculation in short form (for power plant type A and B): First, the energy gain of a turbine 13 is calculated for one section. Here, ¾ of the total amount of water flows through the turbine so that the turbine part (as first power plant part) gives no substantial difference in the amount of energy generated by turbines.

Calculation of the energy of the second power plant part—the piston system: The water leaves the turbine at a flow rate of about 5.3 m/s, as confirmed by the operator of said hydropower plant at Oberelchingen used for comparison. The free fall speed is delayed by the turbines from 10.6 m/s to about 5.3 m, so that the turbine side operates with very high efficiency, even when a power reduction is present, but the now proposed piston system gains more as the water flow is continuously used for generation wherein the sectioned water pressure chamber is used for the drive cylinders, namely in all (four) sections that provide four full piston strokes.

Specifications of the piston system and drive cylinders:

Drive cylinder surface =piston area =5041 dm²

Piston stroke s =20.83 m

Water column height H, piston start at =26,45 m

Pressure force on the piston area =1333345 kg

Piston weight =283367 kg

Stroke dependent water volume in the drive cylinder =1050000 liters

Stroke time =approx. 20 seconds (per piston stroke with complete filling)

In each of the four sections one piston weight is moving upwards—but time- shifted, so that a time offset of 5 sec results at the stroke time of 20 sec. Therefore, all 5 seconds a piston stroke starts. Consequently, all 5 sec a piston stroke ends and thus all 5 sec the water content of a drive cylinder of 1050000 liters discharges into reservoirs 1 at low water level 2. These four piston strokes in the four sectors or sections thus exactly lift the total amount of water of 210 m³/s up to water level 2.

The mechanical energy from the rotation of the drive cylinder (with the piston weights 7 therein) is significantly high, namely in the order of the turbine power. The piston system using the static pressure generates about the same amount of energy as the turbine system, wherein the potential energy stored in the lifted piston weights and the constantly repeating rotations of the drive-crosses 8 is transmitted to an associated generator e.g. via a gear transmission.

As mentioned above, the power plant type B (cf. FIG. 2) does not drain the water to an outlet, but collects the lifted water (f. i. when the water supply is varying) in four water reservoirs 1, which corresponds to the water level 2. From here, water pumps P pump the water into four upper water reservoirs 3, which correspond to the upper water level 4. From this position, water automatically and continuously flows to four turbine inlets 5 and again through the turbines 13 and finally back through the piston system. Thus, the water (or other liquid) flows in a circuit and is repeatedly used, wherein with respect to type A (FIG. 1), the pump energy is considered to consume only approximately 30% of the energy produced by the piston system.

Advantageous Effects vs. conventional hydroelectric power stations:
Gravitational power plant Type A—for use with natural water storage: In this embodiment, an increased amount of energy is generated.
Gravitational power plant Type B—broadly without the use of natural water storage: This version can be installed at any location—even at irregular water supply.

The broad independency from natural water supply by rivers or lakes saves a lot of costs, and the fact that the turbine blades are exposed to particulate wear. In addition, no costs for energy storage reservoirs or long power lines occur.

The gravitational power plant type B can be changed in various ways in its performance, preferably by raising or lowering the free falling height h. By adding additional sections, f. i. when the water supply is staggering, an increase in performance can be effected or the piston weights might be reduced.

To sum up, emissions reductions and energy security can be achieved, and broad independence from raw materials.

1. Gravitational power plant for generating electricity, comprising at least one turbine and one drive cylinder having therein a movable piston weight which can be alternately lifted by the hydrostatic pressure in a low water-pressure chamber, characterized in that the water-pressure chamber is divided by at least one partition wall in at least two, preferably four sections, wherein the respective piston weight is successively lifted to the maximum height at the end of the piston stroke in all sections.

2. Gravitational power plant according to claim 1, wherein at least one water pump is disposed on water height per section to pump up water to the upper water level for continuous, repeated use thereof.

3. Gravitational power plant according to claim 1, wherein three partition walls are arranged in the water-pressure chamber, preferably evenly spaced to form sections each having the same volume.

4. Gravitational power plant according to claim 1, wherein per section at least two drive cylinders are provided which are preferably disposed about 90 degrees to each other.

5. Gravitational power plant according to claim 1, wherein one turbine is provided in each section.
